(19) United States
(12) Patent Application Publication
(10) Pub. No.: US 2017/0347212 A1
(43) Pub. Date: Nov. 30, 2017

(54) RETAINING CAP FOR A STANDARD EARPIECE AND STANDARD EARPIECE

(71) Applicant: SIVANTOS PTE. LTD., SINGAPORE (SG)

(72) Inventors: THOMAS LOTTER, HEROLDSBERG (DE); ERWIN SINGER, ECKENTAL (DE)

(21) Appl. No.: 15/604,166

(22) Filed: May 24, 2017

(30) Foreign Application Priority Data
May 24, 2016 (DE) 10 2016 208 940.4

(51) Int. Cl. H04R 25/00

(52) U.S. Cl. CPC H04R 25/656; H04R 2460/11; H04R 2225/023; H04R 2225/025; H04R 2460/09

(57) ABSTRACT

A standard earpiece which is insertable in an ear canal in a direction of insertion has a corresponding retaining cap. The retaining cap is configured in such a way, in this case, that it equally satisfies the requirements for wearing comfort, a secure seating of the standard earpiece, and proper ventilation of the ear.

### CROSS-REFERENCE TO RELATED APPLICATION

This application claims the priority, under 35 U.S.C. §119, of German application DE 10 2016 208 940.4, filed May 24, 2016; the prior application is herewith incorporated by reference in its entirety.

### BACKGROUND OF THE INVENTION

### Field of the Invention

The invention relates to a retaining cap for a standard earpiece which is insertable into an ear canal in a direction of insertion. Moreover, the invention relates to a standard earpiece containing a corresponding retaining cap.

A plurality of persons around the world are affected by hearing loss and hearing difficulty. The reduction or even the loss of one's hearing negatively affects communication and contact with other persons. Most people who are affected by hearing loss therefore wear hearing aids which enable their users with reduced hearing to have a largely normal auditory perception.

Different designs of hearing aids are offered in order to satisfy the numerous individual needs of hearing aid wearers. In the case of behind-the-ear (BTE) hearing aids, a housing contains components such as a battery and the signal processing unit is worn behind the ear. A flexible sound tube, which is also referred to as a tube, conducts the acoustic output signals of the receiver from the housing to the auditory canal. Receiver-in-canal (RIC) hearing aids are BTE hearing aids which have an electrical connection to a loudspeaker worn in the ear. In the case of the so-called in-the-ear (ITE) hearing aids, a housing which contains all functional components, including the microphone and the receiver, is worn at least partially in the auditory canal. Completely-in-canal (CIC) hearing aids are similar to ITE hearing aids, but are worn completely in the auditory canal.

German utility model DE 202015000840 U1 discloses a hearing aid earmold unit for use at an ear canal for positioning an RIC hearing system, containing an earmold hollow body, a support pocket which is integrated into the insulating plastic and has formed in the end thereof a constriction (clamping) for connecting canal receivers of different RIC hearing aids, and a universal receptacle for manufacturer-specific click sleeves, which is located behind the constriction. The hearing aid earmold provides for a manufacturer-independent, i.e., universal connection possibility for RIC hearing aids.

Published, non-prosecuted German patent application DE 10 2014 200 605 A1 describes a dome which can be reversibly, i.e., detachably, connected to a receiver or hearing tube of a hearing aid. The dome contains a wax guard which can be removed from the receiver or hearing tube easily and preferably without the dome in order to be cleaned. The wax guard according to DE 10 2014 200 605 A1 is softer as compared to the inner part, wherein the inner part is configured for reversibly establishing a form-fitting connection with a correspondingly shaped adapter. In this case, the wax guard contains at least one elongate guard element, wherein a surface projection of each guard element perpendicular to the base surface of the wax guard extends radially relative to the center of mass of the base surface of the wax guard. The design of the wax guard using flexible, elongate elements, which can be designed as spokes or blades, ensures a good cleaning capability of the wax guard. The design of the dome with a harder insert ensures a mechanically stable connection which is nevertheless reversibly detachable for purposes of maintenance or replacement.

U.S. patent publication No. 2015 049 897 A1 describes an earpiece containing a flange having an upper end and a lower end, wherein the flange has a teardrop curve cross-section extending from the upper end to the lower end. The flange further contains an inner body, through which an acoustic canal or sound canal extends. In the inserted state of the earpiece, the flange at least partially closes an auditory canal for ambient noise and forms at least one partial seal with respect to air in the auditory canal. In this case, the sound canal allows sound to pass into the ear canal when the inner body is connected to a sound source.

Independently of the design, it is possible to utilize standardized hearing systems, so-called instant-fit hearing systems. Such instant-fit hearing systems are designed for a preferably universal usability and contain standard earpieces which are sized small enough to be placed in the ear canal of the particular hearing aid wearer independently of the particular anatomy. In the case of a relatively large auditory canal of the hearing aid wearer, such standard earpieces frequently do not have a sufficient hold in the auditory canal, however, since they are not adapted to the individual ear canal or auditory canal of the hearing aid wearer. The earpieces slip easily.

If the standard earpiece is too large, the auditory perception is frequently adversely affected, since the ventilation required for a pressure equalization in the ear cannot always be ensured in this case. Due to the ventilation therefore being low, unpleasant feedback effects are favored (occlusion effect). In addition, standard hearing pieces frequently impart an unpleasant wearing sensation to the hearing aid wearer due to the hard housing material.

Despite the different sizes of the available standard earpieces, an optimal adaptation to the anatomy of the auditory canal of a particular hearing aid wearer is therefore not ensured at this time.

### SUMMARY OF THE INVENTION

A first problem addressed by the invention is that of providing a possibility for allowing an optimal auditory perception and a comfortable seat of the particular hearing aid when a standard earpiece is utilized.

A second problem addressed by the invention is that of providing a corresponding standard earpiece having improved wearing properties and improved hearing comfort.

The first problem of the invention is solved according to the invention by a retaining cap for a standard earpiece, which is insertable into an ear canal in a direction of insertion, containing an end-side headpiece and a blade section adjacent thereto, the retaining cap being configured in such a way that the standard earpiece can be accommodated therein via at least 50% of its length, wherein the blade section is peripherally spaced apart from the standard earpiece.

The invention is based on the fact that standardized earpieces, such as, in particular, CIC hearing aids, RIC hearing aids, or earpieces of a BTE hearing aid can be utilized with installed elastic retaining caps, so-called domes. In this way, a sufficient hold in the auditory canal or in the ear canal of the particular hearing aid wearer can usually be achieved. Auditory perception is not improved as a result, however. Optimal wearing comfort and optimal auditory perception are desired, however.

The invention satisfies these requirements by a retaining cap which adapts to the ear canal and simultaneously ensures sufficient ventilation. For this purpose, the retaining cap is configured with an end-side headpiece and a blade section adjacent thereto. The standard earpiece can be accommodated in the retaining cap, in particular in the blade section of the retaining cap, via at least 50% of its length, and the blade section is peripherally spaced apart from the standard earpiece.

In this case, the retaining cap is configured to be so long, in particular, that, in the state in which it has been installed on the standard earpiece and inserted into the ear canal, it covers the entire length between the isthmus, the constriction in the auditory tube, and the opening into the ear canal. In this way, the fixed hold of the earpiece within the ear canal is ensured. In addition, due to the peripheral separation between the standard earpiece and the retaining cap or its blade section, the standard earpiece is prevented from resting against the wall of the ear canal or impacting the ear canal, thereby ensuring that the hearing aid wearer does not have an unpleasant sensation.

Particularly preferably, the retaining cap includes a number of ventilation openings which extend through the headpiece essentially in parallel to the direction of insertion and open into the inner chamber of the blade section. In the inserted state of the earpiece, the inner chamber is defined by the distance between the inner wall of the retaining cap and the outer wall of the standard earpiece. Since the inner chamber of the blade section is configured to be open on the outwardly directed side of the retaining cap, i.e., at the opening of the ear canal, the inner chamber is a ventilation volume which allows for the necessary ventilation and, therefore, the pressure equalization, via the opening or each opening. An undesired occlusion effect or closure effect is avoided.

Advantageously, the cross-section of the retaining cap expands in the direction of insertion. The headpiece of the retaining cap, which faces the isthmus in the inserted state of the retaining cap (together with the standard earpiece), therefore has a smaller cross-section than the blade section located at the opening of the ear canal.

Particularly preferably, the centers of gravity of the cross-sectional areas of the retaining cap extend along the direction of insertion on a curved path. The retaining cap is therefore configured with a curvature in the direction of insertion. The geometry of the retaining cap, i.e., both the expansion of the retaining cap and its curvature, therefore follows the contour of the ear canal and provides for a secure and comfortable positioning of the earpiece. Nevertheless, the earpiece can therefore be used for a left ear and for a right ear.

The retaining cap or a standard earpiece containing a corresponding retaining cap is preferably reproducibly positionable within the ear canal. For this purpose, the retaining cap is preferably made from two parts having different elasticities and, therefore, different flexibilities. The headpiece preferably has a lower elasticity than the blade section. In particular, the material of the headpiece has a lower elasticity than the material of the blade section. The retaining cap is preferably produced from a plastic.

In order to produce a retaining cap having sections with different elasticities, it is particularly advantageous to manufacture the headpiece and the blade section from the same material, but with wall thicknesses that differ from each other. In this case, the blade section preferably has a smaller wall thickness than the headpiece. A further preferred possibility is that of producing the headpiece and the blade section of the retaining cap with different Shore hardnesses when the same material is utilized. In such a retaining cap, the blade section advantageously has a lower Shore hardness than the headpiece. Alternatively, it can be advantageous to produce the headpiece and the blade section from different materials.

In this case, the headpiece is flexible or elastic enough, on the one hand, to ensure the desired comfort for the hearing aid wearer. On the other hand, the headpiece is sufficiently solid to provide the hearing aid wearer with haptic feedback, during insertion of the earpiece into the ear canal, as to whether the wearer has reached the intended end position, i.e., the isthmus. If this is the case, it is difficult to insert the standard earpiece with the retaining cap installed thereon further past this point. The hearing aid wearer can therefore assume that the earpiece is located in the intended position within the ear canal.

The flexible, more elastic section of the retaining cap, i.e., the blade section, ensures the desired wearing comfort along the wall of the ear canal. Advantageously, the length of the headpiece in the direction of insertion is less than half the length of the blade section.

The retaining cap is advantageously fastenable on the standard earpiece via the headpiece or is fastened on the headpiece in the installed state. For this purpose, the headpiece preferably has a fastening opening for a force- locked connection to the standard earpiece. The fastening opening is preferably formed on the insertion-side end face of the retaining cap. A fastening element of the standard earpiece can be inserted into the fastening opening in order to detachably fix the two components to each other.

The second problem of the invention is solved according to the invention by a standard earpiece containing a retaining cap according to one of the above-described embodiments. Preferably, the force-locked connection is configured as a rotatable clip connection.

The retaining cap is inserted onto the standard earpiece. For this purpose, a fastening element, which is preferably formed on the end face of the standard earpiece, engages into the fastening opening in the retaining cap. The fastening element is preferably rotatably accommodated in the fastening opening. Due to this rotatable embodiment of the clip connection, the standard earpiece, together with the retaining cap, is suitable both for use in the ear canal of the right ear, and in the ear canal of the left ear.

In principle, any earpiece that is located within the auditory canal of the hearing aid wearer in the installed state can be utilized, very generally, as the standard earpiece. Particularly preferably, the standard earpiece is configured as a standard CIC hearing aid. The housing of the hearing aid terminates in the outer part of the auditory canal and is therefore hardly visible or is invisible from the outside. The retaining cap is installed on the hearing aid as described above and equally satisfies the requirements for wearing comfort, a secure seat, and the ventilation of the ear.

The advantages mentioned with respect to the preferred embodiments of the retaining cap can be transferred analogously to corresponding embodiments of the standard earpiece.

Other features which are considered as characteristic for the invention are set forth in the appended claims.

Although the invention is illustrated and described herein as embodied in a retaining cap for a standard earpiece, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration showing an instant-fit CIC hearing aid, with installed retaining cap, inserted in an ear canal, according to the invention;

FIG. 2 is a three-dimensional representation of the retaining cap according to FIG. 1;

FIG. 3 is a three-dimensional representation of the instant-fit CIC hearing aid according to FIG. 1;

FIG. 4 is a further three-dimensional representation of the retaining cap according to FIG. 1; and

FIG. 5 is a sectional representation of a portion of the retaining cap according to FIG. 1.

### DETAILED DESCRIPTION OF THE INVENTION

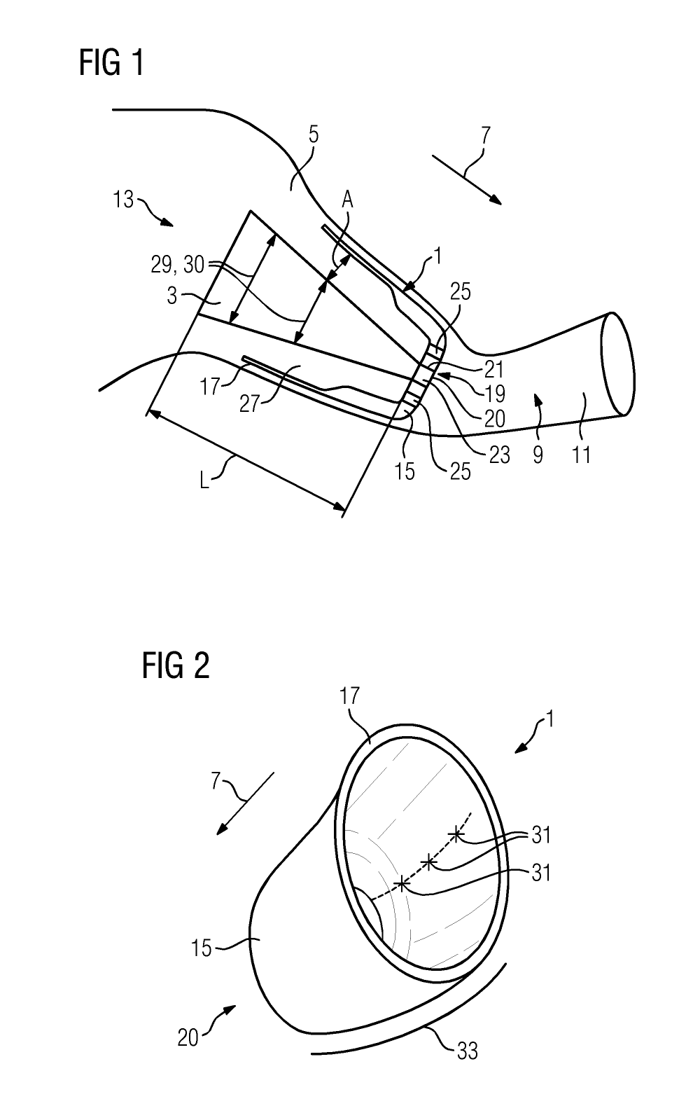

Referring now to the figures of the drawings in detail and first, particularly to FIG. 1 thereof, there is shown a retaining cap 1 which has been installed on a standard earpiece 3 designed as an instant-fit CIC hearing aid. The instant-fit CIC hearing aid 3 including the retaining cap 1 has been inserted within an ear canal 5. In order to insert the instant-fit CIC hearing aid 3 including the installed retaining cap 1, the two components are slid jointly into the ear canal 5 in the direction of insertion 7. In this case, the retaining cap 1 covers the entire length between an isthmus 9, i.e., the constriction in an auditory tube 11, and the opening 13 into the ear canal 5.

The retaining cap 1 has an end-side headpiece 15 and a blade section 17 adjacent to the headpiece 15, wherein the length of the headpiece 15 in the direction of insertion 7 is less than half the length of the blade section 17.

The headpiece 15 has a lower elasticity than the blade section 17. If the instant-fit CIC hearing aid 3 is inserted into the ear canal 5, when the end position is reached, i.e., when the isthmus 9 has been reached, it becomes difficult to insert the instant-fit CIC hearing aid 3 any further. The hearing aid wearer then knows that the instant-fit CIC hearing aid 3 is positioned far enough in the ear canal 5.

By way of the flexible blade section 17, it is ensured that the retaining cap 1 adapts to the anatomy of the ear canal 5, and therefore the desired wearing comfort for the hearing aid wearer is achieved.

The retaining cap 1 is fastened on the instant-fit CIC hearing aid 3 via a force-locked, rotatable clip connection 19. For this purpose, a fastening opening 21 is formed on the insertion-side end face 20 of the headpiece 15, into which a fastening element 23, such as, for example, a ball head, of the standard earpiece 3 engages.

The standard earpiece 3, i.e., the instant-fit CIC hearing aid, is accommodated within the retaining cap 1 via 75% of its length L in this case. The blade section 17 is peripherally spaced apart from the standard earpiece 3 in this case. Due to the peripheral separation between the instant-fit CIC hearing aid 3 and the retaining cap 1 or its blade section 17, the instant-fit CIC hearing aid 3 is prevented from resting against the wall of the ear canal 5 and thereby applying pressure which is unpleasant for the hearing aid wearer.

In order to ensure the ventilation of the ear or the pressure equalization which is necessary for optimal auditory perception, the retaining cap 1 has multiple ventilation openings 25 which extend through the headpiece 15 essentially in parallel to the direction of insertion 7 and open into the inner chamber 27 of the blade section 17. The inner chamber 27 in this case is defined by an annular space having a distance A between the inner wall of the retaining cap 1 and the outer wall of the instant-fit CIC hearing aid 3.

The ventilation openings 25, as well as the fastening opening 21, are formed on the insertion-side end face 20 of the headpiece 15. In combination with the inner chamber 27 resulting from the peripheral separation between the standard earpiece 3 and the blade section 17 of the retaining cap 1, a ventilation of the ear can take place through the inner chamber 27 of the retaining cap 1. Ventilation openings in the instant-fit CIC hearing aid 3 are not necessary.

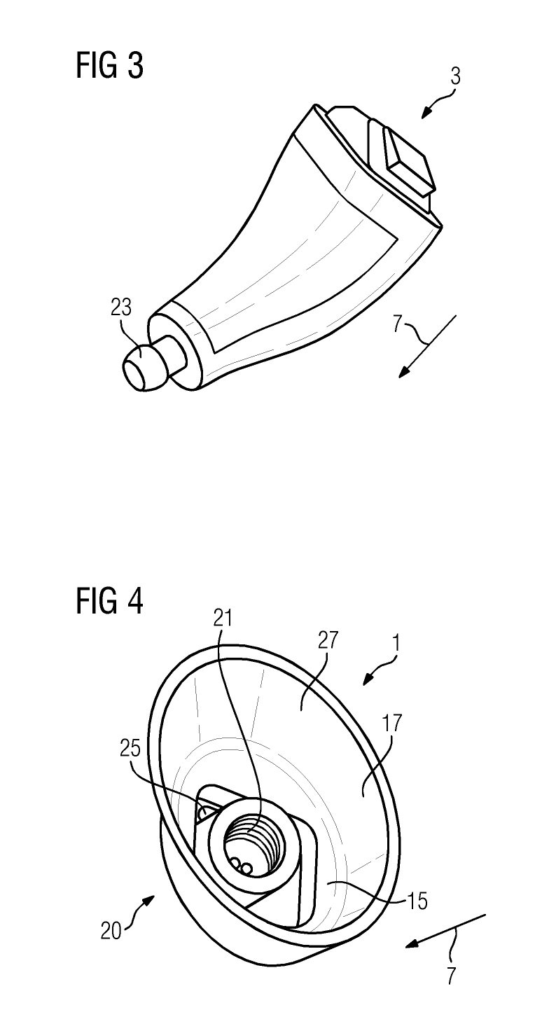

A cross-section 29 of the retaining cap 1 expands counter to the direction of insertion 7, i.e. a cross-sectional areas 30 become larger counter to the direction of insertion 7. In this case, centers of gravity 31 of the cross-sectional areas of the retaining cap 1 extend along the direction of insertion 7 on a curved path 33. This is apparent in particular in the representation of the retaining cap 1 according to FIG. 2. The curvature of the retaining cap 1, which is marked for a few cross-sectional areas (not labeled), by way of example, is evident here. The centers of gravity 31 of the cross-sectional areas do not lie on a straight line. Due to the curvature, the shape of the retaining cap 1 is adapted both to the shape of the ear canal and to the shape of the instant-fit CIC hearing aid 3. The curvature mirrors the anatomy of the ear canal 5.

The instant-fit CIC hearing aid 3 is shown in an isolated representation in FIG. 3. Its curved shape is also apparent from the representation. In addition, the end-face fastening element 23, which is used for fastening the retaining cap 1, is apparent. When the retaining cap 1 is installed, the fastening element 23 engages into the fastening opening 21 formed on the insertion-side end face 20 of the headpiece 15. In this way, the force-locked and rotatable clip connection 19 between the instant-fit CIC hearing aid 3 and the retaining cap 1 is established.

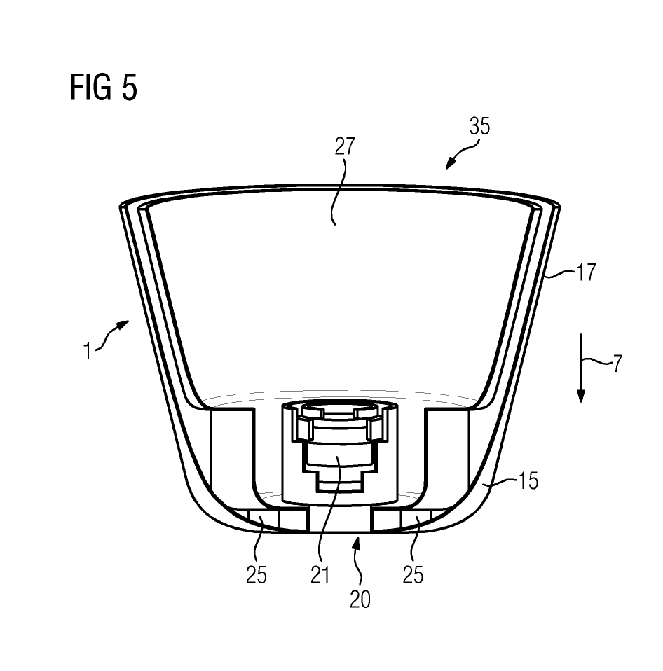

The fastening opening 21 of the retaining cap 1 is shown clearly once more in FIGS. 4 and 5. FIG. 4 shows one of the ventilation openings 25 which extend through the headpiece 15 essentially in parallel to the direction of insertion 7 and open into the inner chamber 27 of the blade section 17. It is also evident from the representation according to FIG. 4 that the length of the less elastic and, therefore, less flexible headpiece 15 in the direction of insertion 7 is less than half the length of the blade section 17.

FIG. 5 shows a sectional representation of a portion 35 of the retaining cap 1. This representation shows the ventilation openings 25 and the fastening opening 21 on the insertion-side end face 20 of the headpiece 15. In addition, the transition between the headpiece 15 forming the retaining cap 1 and the blade section 17 adjacent thereto is apparent.

The following is a summary list of reference numerals and the corresponding structure used in the above description of the invention:
1 retaining cap
3 standard earpiece
5 ear canal
7 direction of insertion
9 isthmus
11 auditory tube
13 opening
15 headpiece
17 blade section
19 clip connection
20 end face
21 fastening opening
23 fastening element
25 ventilation opening
27 inner chamber
29 cross-section
30 cross-sectional area
31 center of gravity
33 curved path
35 portion
L length of the standard earpiece
A distance

1. A retaining cap for a standard earpiece being insertable into an ear canal in a direction of insertion, the retaining cap comprising:
an end-side headpiece; and
a blade section adjacent to said end-side headpiece, the retaining cap is configured such that the standard earpiece can be accommodated in said blade section via at least 50% of a length of the standard earpiece, wherein said blade section is peripherally spaced apart from the standard earpiece.

2. The retaining cap according to claim 1, wherein:
said blade section has an inner chamber; and
said end-side headpiece has a number of ventilation openings formed therein which extend through said end-side headpiece generally in parallel to the direction of insertion and open into said inner chamber of said blade section.

3. The retaining cap according to claim 1, wherein the retaining cap has a cross-section which expands counter to the direction of insertion.

4. The retaining cap according to claim 3, wherein centers of gravity of cross-sectional areas of the retaining cap extend along the direction of insertion on a curved path.

5. The retaining cap according to claim 1, wherein said end-side headpiece has a lower elasticity than said blade section.

6. The retaining cap according to claim 1, wherein said end-side headpiece has a length in the direction of insertion being less than half a length of said blade section.

7. The retaining cap according to claim 5, wherein said end-side headpiece has a fastening opening formed therein for a force-locked connection to the standard earpiece.

8. The retaining cap according to claim 1, wherein a material of said end-side headpiece has a lower elasticity than a material of said blade section.

9. A standard earpiece being insertable into an ear canal in a direction of insertion, the standard earpiece comprising:
a main earpiece body; and
a retaining cap having an end-side headpiece and a blade section adjacent to said end-side headpiece, said retaining cap configured such that said main earpiece body is accommodated in said retaining cap via at least 50% of a length of said main earpiece body, wherein said blade section is peripherally spaced apart from said main earpiece body.

10. The standard earpiece according to claim 9, wherein said end-side headpiece has a force-locking connection for connecting to said main earpiece body and is configured as a rotatable clip connection.

11. The standard earpiece according to claim 9, wherein the standard earpiece is configured as a standard completely-in-canal hearing aid.
